(19) United States
(12) Patent Application Publication
(10) Pub. No.: US 2009/0023106 A1
(43) Pub. Date: Jan. 22, 2009

(54) Teeth treatment device

(76) Inventor: Scott Jacobs, Lakewood, CO (US)

Correspondence Address: John S. Munday;Law Offices of John S. Munday, PO BOX 423, Isanti, MN, 55040, US

(21) Appl. No.: 11/880,004

(22) Filed: Jul. 19, 2007

(51) Int. Cl. A61C 9/00

(52) U.S. Cl. 433/48

(57) ABSTRACT

A tray device for use in treating a patient's teeth using a pattern formed from dental wax having a length and height sufficient to cover the patient's teeth. The pattern is packaged in a packaging platform for forming a tray shaped device by pressing the pattern on the platform to thereby form a tray sized to cover the selected teeth on the teeth. The package holding the platform may also have a hollow region sized and positioned to cover the pattern on the platform. The dental wax is sufficiently deformable at room temperature to permit a patient to conform the tray to the teeth.

### FIELD OF THE INVENTION

The present invention relates to making a dental tray customized to an individual patient's teeth, without the necessity of professional service, and the method to customize the dental tray. More particularly, the invention relates to the use of simple wax materials to allow individuals to brighten or bleach their own teeth without visiting a dental office or laboratory. Other conventional treatments are also contemplated.

### BACKGROUND OF THE INVENTION

Dental trays are receptacles that are used to carry a medicine or dental hygiene materials, such as bleaching agents or fluoride application, and apply them to the teeth. It confines the material next to the teeth during the application. Bleaching is becoming more popular with the general public because efforts have been made to simplify the bleaching process and provide devices useful for home care and treatment by individuals without professional supervision.

There are three types of dental trays: stock, customized and extremely thin grays. Stock trays are pre-fabricated into a variety of standard sizes. They are used only for preliminary procedures and to produce impressions for casting as an interim step to creating more accurate dental trays and models of teeth. Custom trays are made by a dentist or technician by molding a material over a gypsum model of the patient's teeth. In order to get the gypsum model, a preliminary impression is made from the patient's teeth. The model requires at least one dental visit and requires a laboratory to construct the gypsum model. The extremely thin plastic flat strips or extremely thin preformed plastic trays have no memory. When preloaded with bleaching gels, or when bleaching gels are placed on them, they conform to the teeth holding the gels against the teeth. They may have texturing creating a reservoir for the gel solutions against the teeth. They can be manufactured form plastic sheet material or can be formed by injection molding or thermoforming from sheet plastic sheet material using a die along with heat and pressure to obtain the desired shape.

Once the model is made, the customized dental tray is formed by the dentist or lab according to the limitations of the materials to be used for the tray. If the tray is made of thermoplastic sheets, the tray may be formed in a vacuum forming machine or other machine which exerts pressure. The sheets are placed in a soft state over the model and pressure is applied while the material sets.

Jacobs et al. U.S. Pat. No. 6,896,518 discloses a teeth treatment device in which dental wax is formed into a pattern with cut-out portions and a score line to facilitate folding the pattern into the proper shape. This requires a precise mold. Packaging is not the easiest as it is necessary to keep each device separate from others so they do not stick together. The precise mold is a steel rule die which cuts the wax sheet into the desired form. Packaging has to be flat with separation sheets to keep the wax from sticking together or in individual packettes. In either case, the cut sheets of the Jacobs patent would be in a flat format only and there is no mention of a three-dimensional tray until it is formed in the mouth.

It would be a great advantage to provide a simple method and device for whitening teeth, particularly if the device uses commonly known dental materials.

Still another advantage would be to provide a device that can be packaged together with other identical devices for increased convenience to the purchaser and user.

Yet another advantage would be to produce a dental bleaching tray that can also be used for other purposes, such as fluoride treatment, anti-bacterial treatments and the like.

Other advantages will appear hereinafter.

### SUMMARY OF THE INVENTION

The present invention is an assembly of either or both of two components, referred to as the upper and lower jaw pattern forms. In one embodiment, the upper pattern can be used for both the upper and lower teeth. Pattern forms are sized to allow the device to generally conform to the patient's teeth and extends to the gum line or gingival margin. Both the upper jaw and lower jaw patterns are die cut from commercially available dental wax. In its simplest form, the cut pattern is then pressed on to a molded package that has the shape that the pattern is to conform to, so that it is ready to use.

The package and folded pattern may additionally have a treating agent placed on the inside of the pattern before packaging, or it may have a treating agent added after it is removed from the package. Other solutions can also be used with this tray, such as fluoride treatment, anti-bacterial treatments and the like. The rest of the package can now be placed on the molded package.

The package platform has at least one and preferably a plurality of raised “clam” like shapes that gives the pattern the “L” shape it needs for use in the patient's mouth. The pattern is placed on the raised shape and pressed to form it. In a preferred embodiment, the package may also have a second layer of raised shapes that cover the formed pattern to keep it clean and safe until it is used. The preformed wax trays could also be placed in individual packaging. A preformed wax tray can be pre-loaded and placed in a contoured plastic box that matches the shape of the tray with a tear away hermitically sealed foil top. This type of packaging would preferably be used with preloaded trays.

The term “dental wax” is well known in the art and describes a large number of products of various compositions and components, all of which are known by this generic term. The preferred wax is paraffin wax, and the preferred dental waxes of the present invention contain at least 25 percent by weight of paraffin wax, and preferably over 40 percent by weight paraffin wax. Other components may be resins such as polyvinyl acetate and other synthetic resins that are compatible with the human body, in that they do not have a harmful affect on the user. One preferred dental wax is manufactured by Hase Petroleum Wax Co. of Arlington Heights, Ill., and is sold under the trade name HP11168 dental wax. This preferred dental wax has a melting point (ASTM D-3954) of between about 140° F. and 160° F., and softens at less than 98° F. so that it can be used as described herein.

The invention provides a simple dental tray that is easily and inexpensively made without the necessities of repeat visits to a dentist or doctor, and without the necessity of sophisticated equipment or technicians.

### DESCRIPTION OF DRAWINGS

For a more complete understanding of the invention, reference is hereby made to the drawings, wherein like numbers refer to like elements, and in which:

FIG. 1a is a side elevational view of the preferred embodiment of the present invention, prior to forming its intended shape;

FIG. 1b is perspective view of the preferred embodiment of FIG. 1a;

FIG. 1c is a section view taken along line A-A of FIG. 1b;

FIG. 2a is a side elevational view of another, simpler embodiment of the present invention, prior to forming its intended shape;

FIG. 2b is perspective view of the embodiment of FIG. 2a;

FIG. 2c is a section view taken along line B-B of FIG. 2b; and

FIG. 3 is a perspective view of the other component of the present invention.

### DETAILED DESCRIPTION OF THE INVENTION

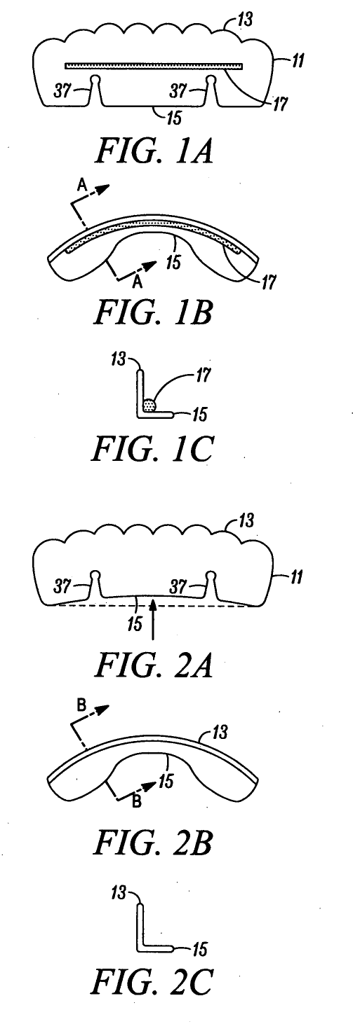

As shown in the drawings, the present invention comprises a thin dental wax pattern that can be folded to form a bleaching tray. FIGS. 1a, 1b and 1c are identical to FIGS. 2a, 2b and 2c, except that the treating agent is added to the first set of figures and is absent until the tray is used in the second set of figures.

A strip of wax 11 is formed into a pattern that is shaped to cover the front and back of the user's teeth, either in the upper or the lower jaw, so that when it is placed in the mouth, both sides and the top of the teeth are in contact with the wax. Strip 11 can be used in either the upper or lower teeth. In another embodiment, different patterns can be used for upper and lower teeth treatment. The strip 11 has a plurality of curves 13 on one side that will engage the gum line or gingival margin. Strip 11 also has a single arc 15 on the other side that provides space for the tongue.

In FIGS. 1a, 1b and 1c, a strip 17 is also provided for treating the teeth. Strip 17 is preferably an encapsulated gel for bleaching in a roll of wax. By encapsulating the bleaching agent into a gel, and placing the gel in a wax tube, the bleaching agent is protected. This preserves the bleach and eliminates the need for air tight packaging. The encapsulated gel is contained in a tube of wax which is thinner than the walls and bottom of the wax tray. This allows the user to easily bite through the wax tube, releasing the gel to the coat the surfaces of the teeth without biting through the walls or the bottom of the tray.

As noted above, the dental wax 11 is thin, ranging from about 0.02 to 0.08 inches thick, with about 0.0245 inch thickness (0.60 mm) being preferred. The wax is capable of softening at body temperature, of less than 98.6° F., and is contoured by being held between the user's fingers and thumb before being placed on the teeth for forming. Another way of warming the wax for application is to simply hold it under the warm water tap while running the warm water for a few minutes. One preferred dental wax is the previously described Hase Petroleum Wax Co. dental wax HP11168. This preferred dental wax has a melting point (ASTM D-3954) of between about 140° F. and 160° F., and softens at less than 98° F. Strip 17 can be any convenient size, preferably between 0.01 and 0.05 inches, with about 0.016 (0.40 mm) being preferred. Another Hase Petroleum Wax Co. product that is suitable for use in the present invention is 133-138° F., a penetration @ 77° F. (ASTM D1321) of 23-33 dmn and a viscosity @ 212° F. (ASTM D445) of between 5.5 and 8.5 cS.*°

It should be noted that the tray of the present invention is capable of covering the entire set of teeth up to the gum line or gingival margin. Once the tray is warm, it is placed over the teeth. Finger pressure is used to pack the tray against the front and back, and then the jaw is closed to bite gently, to replicate the tops of the teeth as well. Thus a total treatment of all the teeth, or any region of the upper or lower teeth, can effectively be achieved. Finally, the top of the tray can be trimmed with scissors or a hot instrument, and then flame polished to eliminate any sharp edges.

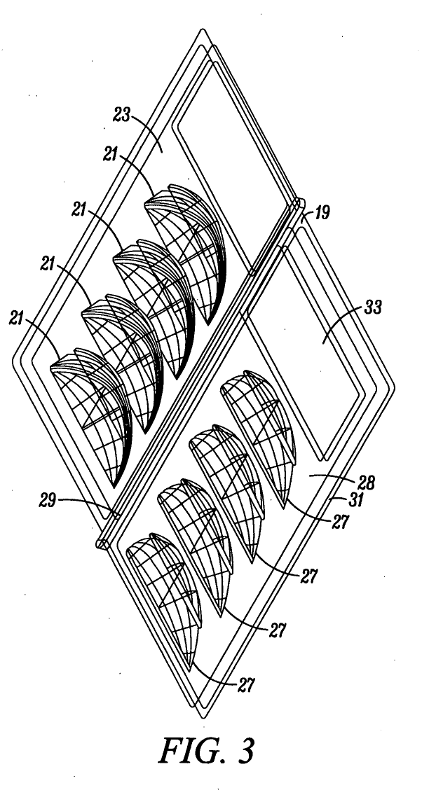

FIG. 3 illustrates the preferred packaging platform. The package 19 includes one or more tray forming portions 21 that are raised up and shaped to receive the wax strip 11 and the strip 11 is pressured on the tray forming portion 21. For practical marketing reasons, a plurality of portions 21 are contemplated to be used. Package 19 has the raised up portions 21 that are formed on the back 23 of package 19. A front portion 28 of package 19 includes a similar number of hollow portions 27 that fit over strips 11 on packaging platforms 21. Packaging platforms 21 and hollow portion 27 are then brought together by mating back 23 and front 28 using hinge 29. The back 23 and front 28 also preferably have a clasp 31 or other means for closing the two together to form the final product. Advertising and instructions can be printed on any of the device. FIG. 3 shows one such area 33.

The finished tray that has been formed to fit the user is then removed and bleaching solutions are placed in the tray. The inside of the tray is textured, such as by pressing during the cutting stage during manufacture, to hold the bleaching solution. Preferred bleaching solutions and other solutions that affect the appearance of the teeth are, without limitation, hydrogen peroxide, carbamide peroxide, sodium fluoride, sodium monofluorophosphate, pyrophosphate, chlorhexidine, polyphosphate, triclosan and enzymes. One preferred treatment agent is a chlor-haidine solution used as an antibacterial agent for the treatment of gingivitis. Another preferred treatment agent is potassium nitrate for the treatment of tooth sensitivity.

As has been noted above, the present invention may be used for bleaching but other dental procedures are also within the scope of the invention, including whitening, stain bleaching, stain removal, remineralization, plaque removal and tartar removal. It is contemplated that the tray of the present invention will cover all or only some of the patient's teeth, depending on the treatment in use. Simple cosmetic bleaching often does not include any teeth that are not visible in normal smiling and the like, such as those back from the first bicuspid.

The tray is now ready for use. The cost of using the invention described herein is much less than that of a dental office.

While particular embodiments of the present invention have been illustrated and described, it is not intended to limit the invention, except as defined by the following claims.

1. A tray device for use in treating at least some of a patient's teeth, comprising:
a pattern formed from dental wax, said pattern having a length sufficient to cover the selected patient's teeth and a height twice the nominal length of the selected patient's teeth on said teeth; and
a packaging platform for forming a tray shaped device by pressing said pattern on said platform to thereby form a tray sized to cover said selected teeth on said teeth, said dental wax being sufficiently deformable at room temperature to permit a patient to conform said tray to said teeth on said one jaw.

2. The device of claim 1, wherein said device further includes a quantity of treating agent on the inside of said pattern prior to forming said tray on said packaging platform.

3. The device of claim 2, wherein said treating agent is encapsulated and enclosed in a bead of dental wax.

4. The device of claim 3, wherein said treating agent is a bleaching agent.

5. The device of claim 4, wherein said bleaching agent is selected from the group consisting of carbamide peroxide in a concentration of from about 1% to about 50% and hydrogen peroxide in a concentration of from about 1% to 20%.

6. The device of claim 5, wherein said carbamide peroxide in a concentration of from about 5% to about 30% and said hydrogen peroxide is in a concentration of from about 5% to 14%.

7. The device of claim 1, wherein said dental wax pattern is thin, ranging from about 0.02 to about 0.08 inches thick.

8. The device of claim 1, wherein said packaging platform comprises at least one raised platform elements formed on a package back and sized to shape said wax pattern into said tray.

9. The device of claim 9, wherein said packaging platform further includes at least one hollow element positioned on a package front, said package front and package back being sized to cover said wax pattern by mating said package front and package back to each other.

10. The device of claim 2, wherein said treating agent is formed into a bead of dental wax having a diameter of from about 0.005 to about 0.02 inches.

11. A method of making a tray device for use in treating at least some of a patient's teeth, comprising the steps of:
forming a pattern from dental wax, said pattern having a length sufficient to cover the selected patient's teeth and a height twice the nominal length of the selected patient's teeth on said teeth; and
forming a tray shaped device by pressing said pattern on a packaging platform to thereby form a tray sized to cover said selected teeth on said teeth, said dental wax being sufficiently deformable at room temperature to permit a patient to conform said tray to said teeth on said one jaw.

12. The method of claim 11, which further includes providing a quantity of treating agent on the inside of said pattern prior to forming said tray on said packaging platform.

13. The method of claim 12, wherein said treating agent is formed into a bead of dental wax.

14. The method of claim 13, wherein said treating agent is a bleaching agent.

15. The method of claim 14, wherein said bleaching agent is selected from the group consisting of carbamide peroxide in a concentration of from about 1% to about 50% and hydrogen peroxide in a concentration of from about 1% to 20%.

16. The method of claim 15, wherein said carbamide peroxide in a concentration of from about 5% to about 30% and said hydrogen peroxide is in a concentration of from about 5% to 14%.

17. The method of claim 11, wherein said dental wax pattern is formed in a thin thickness ranging from about 0.02 to 0.08 inches thick.

18. The method of claim 11, said packaging platform comprises at least one raised platform elements formed on a package back and sized to shape said wax pattern into said tray.

19. The method of claim 11, wherein said packaging platform further includes at least one hollow element positioned on a package front, said package front and package back being sized to cover said wax pattern by mating said package front and package back to each other.

20. The method of claim 12, wherein said treating agent is formed into a bead of dental wax having a diameter of from about 0.005 to about 0.02 inches.
